(19) United States
(12) Patent Application Publication
(10) Pub. No.: US 2009/0049260 A1
(43) Pub. Date: Feb. 19, 2009

(54) HIGH PERFORMANCE DATA DEDUPLICATION IN A VIRTUAL TAPE SYSTEM

(76) Inventor: Shivarama Narasimha Murthy Upadhyayula, Bangalore (IN)

Correspondence Address: Shivarama Narasimha Murthy Upadhyayula, 9/2, SapthaNilaya Apartments, 3rd Temple Street, 15th Cross, Malleshwaram, Bangalore, 560003, omitted

(21) Appl. No.: 12/190,019

(22) Filed: Aug. 12, 2008

(30) Foreign Application Priority Data
Aug. 13, 2007 (IN) 1804/CHE/2007

(51) Int. Cl. G06F 12/00

(52) U.S. Cl. 711/162; 711/E12.001

(57) ABSTRACT

Data deduplication in a storage system, achieving high performance due to minimal overhead during a backup operation, reduced disk read operations to locate duplicate data and minimal impact for restore operations involving deduplicated data.

### FIELD OF THE INVENTION

The present invention relates to backup storage systems, and more specifically to data deduplication in disk based backup systems such as a virtual tape library

### DEFINITIONS FOR TERMS USED

Data blocks: The user/application data received by a backup host that needs to be stored on disk. The size of a block is variable but generally a multiple of the sector size of the disk. Metadata: Information regarding the data blocks. The metadata is used to locate data blocks, maintain information about the data blocks written etc. The metadata or a portion of the metadata is also written to disk.

### BRIEF DESCRIPTION OF THE DRAWINGS

The invention would be described with reference to the accompanying drawings briefly described below

FIG. 1 illustrates an example virtual tape library system.

FIG. 2 illustrates the association between the virtual tape descriptor block and a virtual tape partition.

FIG. 3 illustrates the metadata layout for the virtual tape descriptor block.

FIG. 4 illustrates the virtual tape partition information which is stored in a virtual tape descriptor block.

FIG. 5 illustrates the layout for a TAllocMap.

FIG. 6 illustrates the metadata layout for a TSegmentEntry.

FIG. 7 illustrates the association between the TAllocMap(s), TSegmentEntry(s) and Disk Segments.

FIG. 8 illustrates the metadata layout for a BlkMap.

FIG. 9 illustrates the metadata layout for a BlkEntry.

FIG. 10 illustrates the metadata layout for a MapLookup.

FIG. 11 illustrates the metadata layout for a MapLookupEntry.

FIG. 12 illustrates the association between MapLookup(s), MapLookupEntry(s), BlkMap(s) and BlkEntry(s).

FIG. 13 describes an example layout of a backup data set.

FIG. 14 illustrates the metadata layout for a DEntryHeader.

FIG. 15 illustrates the metadata layout for a DEntry.

FIG. 16 illustrates the metadata layout for a FEntry.

FIG. 17 illustrates the metadata layout for a SparseLookup.

FIG. 18 illustrates the metadata layout for a SparseInfo.

FIG. 19 illustrates the metadata layout for a DDLookup.

FIG. 20 illustrates the layout of TAllocMap(s), BlkMap(s) etc. in a meta-segment.

FIG. 21 illustrates the relationship between the DEntryHeader(s), DEntry(s) etc.

FIG. 22 illustrates the logic involved on a write command.

FIG. 23 illustrates the logic involved on a read command.

FIG. 24 illustrates the logic involved on a locate command.

FIG. 25 illustrates the logic involved for parsing a backup dataset.

FIG. 26 illustrates the logic involved in the fingerprint computation for a file/file segment

FIG. 27 illustrates an example layout of DEntryHeader(s), DEntry(s) in a virtual tape.

FIG. 28 illustrates a scenario where in the data span referenced by a BlkEntry is identical with the data span in a previous data-segment but the information regarding the data span in the previous data-segment is referenced by more than a one previous BlkEntry.

In the drawings, like reference numbers generally indicate identical, functionally similar, and/or structurally similar elements. The drawing in which an element first appears is indicated by the leftmost digit(s) in the corresponding reference number.

### BACKGROUND OF THE INVENTION

Traditional backup methods involved writing data on to data storage tapes for longer archival of data. Tapes are considered slower when compared to disk based storage. Virtual tape library (henceforth as VTL) systems emulate a tape based library system and to a backup host it would appear as a physical tape library. However the data is backed up to a virtual tape rather than to a real physical tape. The virtual tape is usually a portion of disk on which backup data is written to and read from.

Backups performed by a host comprises of a plurality of backup datasets. A backup dataset comprises the backup data in a format understood by the backup application. Example of a backup formats are the CPIO and TAR format. The backup data usually comprises of a collection of user/application data such as directories, files, etc.

A backup dataset can contain file data or portions of file data that never changed between one or more previous datasets. Data deduplication is a technique where in data blocks from one dataset identical to data blocks in a previous dataset are identified and instead of storing the duplicate data blocks pointers to the identical data blocks are maintained. Data deduplication can be applied at a file level, where file(s) containing the same data between datasets are identified, and the data for only one file(s) is stored. Similarly it can be applied at a sub file level where in specific segments of the files are used for comparison.

Deduplication can also be applied at a block level, where in the comparison is based on a blocks of data. The backup data received from a host is divided into fixed or variable sized chunks and these chunks are compared against chunks from a previous backup data.

Hash algorithms such as MD5, SHA-1 etc are used to generate a hash checksum (henceforth as fingerprint) for data blocks. If two fingerprints match then it is assumed that the block(s) the fingerprint correspond contain identical data. For example if the fingerprint generated for a file data is identical with the fingerprint generated for another file data then the two files can be assumed to contain identical data. Alternatively the data blocks can also be compared for every byte to ensure that the data contained in them are identical.

Prior art data deduplication methods can be in general classified as either inline (inband) or post-processing (out-of-band). In the inline approach when the backup data blocks are received the system would try and identify previous data blocks containing identical data and if found the data blocks from the backup are not stored but pointers to the previous data blocks is maintained. The advantage with the inline approach is that duplicate data blocks are never stored on disk and the data deduplication operation completes along with the backup operation. However the disadvantage of the inline approach is that it would slow down the backup operation.

With the post-processing data deduplication method, the entire backup operation is completed before the data deduplication operation commences. The advantage is that the backup operation is not affected. However with post-processing the newly stored data blocks have to be read again from the disk sub system for any kind of comparison. This is not the case with inline data deduplication since the new data blocks would have been available for comparison in the system's memory as opposed to disk. Reading data from disk is generally a slower operation than reading from system memory.

As a result of data deduplication, the data blocks that belong to a backup dataset may now be spread across the disk storage subsystem unlike prior to data deduplication where in the data blocks can be stored in a sequential layout. Due to this effect restores from a dataset comprising of blocks of data which are deduplicated can be much slower than from a dataset comprising of non deduplicated data blocks. Also reading data corresponding to the deduplicated data blocks may involve traversing data pointers, table lookups etc. before the data blocks can be retrieved.

### DESCRIPTION OF THE INVENTION

The present invention describes a method for high performance data deduplication wherein
1. The disk subsystem comprises a plurality of disk segments where in a segment can be either a metadata disk segment (henceforth as meta-segment) or a data disk segment (henceforth as data-segment). The data-segment(s) contain the backup data as received by a host and the meta-segment(s) contain metadata information about the data blocks in the data-segment(s).
2. An incoming backup data is parsed for directory, file and file segment information corresponding to a file. Fingerprint(s) for the data corresponding to the file segments is computed. Depending on the size of the file in the backup dataset a fingerprint is calculated either for the entire file data or segments of the file data. In case the fingerprint is calculated for an entire file data the file is considered to have a single file segment where the file segment corresponds to the file data.
3. The information about the files, directories etc. in the dataset and the fingerprint(s) information for file data are stored in the meta-segment(s).
4. The data deduplication operation is performed after the backup operation has completed.
5. During the data deduplication operation, the fingerprint information for a file data in the newly stored backup data is compared with the fingerprint information of a file from a previous backup having the same file path information. Identification of a previous file is based on the path information of the file in the backup dataset.
6. Based on the fingerprint information data blocks which are identical to a file's data blocks from a previous backup dataset are identified as possible candidates for deduplication and if the total number of such data blocks in a data-segment meet a minimum criterion the data-segment is identified for deduplication.
7. For the identified data-segment the metadata corresponding to the data-segment is modified such that the data blocks for which duplicates are available are changed to correspond to the duplicate blocks in the previous data-segment(s). For data blocks which do not have duplicates present, the data blocks are copied on to another data-segment. The identified data-segment is then released back to the free disk segment pool.

### High Performance is Achieved Since

1. The impact on the backup process is minimal since the data deduplication process is not performed during the backup operation. Additional overhead during the backup operation is only for the fingerprint computation and storage of the file, directory and fingerprint information in the meta-segment(s).
2. During the data deduplication operation the newly stored data blocks do not have to be read from the disk subsystem to compute fingerprint information since the fingerprints were computed when the data blocks were present in the system's memory.
3. If byte comparison of the data identified for deduplication is also needed, the byte comparison needs to be performed only for those data blocks for which the fingerprint is identical.
4. Metadata corresponding to duplicate data in data-segment, after the deduplication of the data-segment would in general correspond to data in one or two data-segment(s). Thus the locality of data is still maintained within a few data-segment(s) thereby keeping disk seek operations to a minimum.
5. Metadata required to retrieve backup data would always directly reference the required data even after deduplication. This avoids the need for additional lookups to retrieve data thereby achieving high restore performance.

### A. Virtual Tape Library (VTL) System

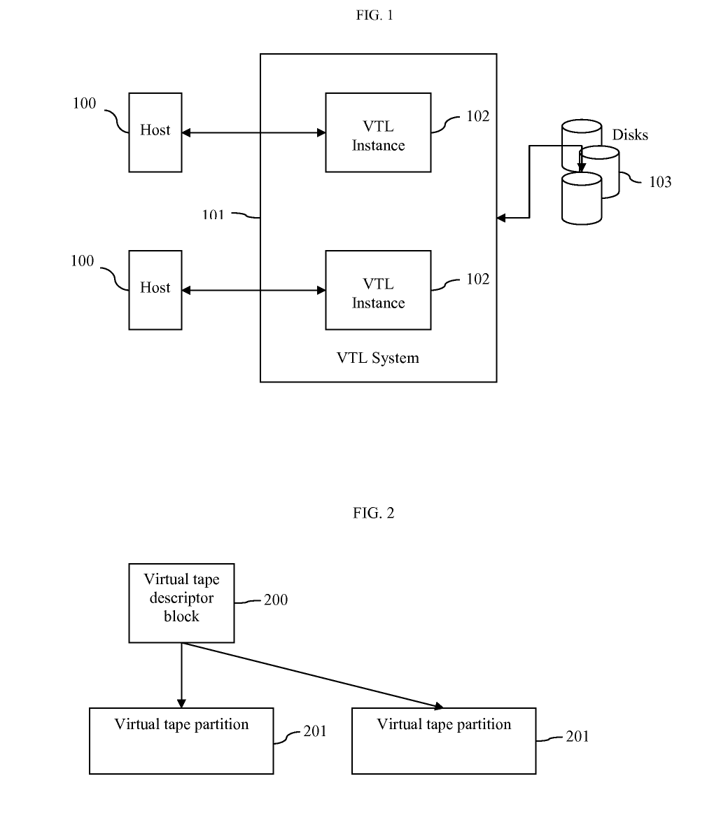

FIG. 1 is a schematic block diagram of an example VTL system which can be used to take advantage of the present invention. A VTL system (101) is an independent computing system with its own processor(s), attached disk subsystem (103) etc., connected and communicating with a plurality of backup hosts (100). The connectivity can be many means such as Fiber Channel, parallel SCSI, and Ethernet etc. The protocols used for communication are usually SCSI over Fiber Channel, iSCSI etc. Multiple computing systems can collectively form a single VTL system and usually termed as clustered VTL system.

A VTL instance (102) in a VTL system virtualizes the elements of a tape library system such that to a backup host it would appear exactly as a physical tape library system. Multiple VTL instances can be created in a VTL system each with ability to emulate a physical tape library. A VTL system can be considered as a plurality of VTL instances.

During a backup operation by a host, the data received by a VTL instance from a host is stored in a virtual tape. A virtual tape can be termed as portion of disk space on the disk subsystem attached to the VTL system. Similarly backed up data is read from the disk subsystem and returned to a host during a restore operation. It will be apparent to those skilled in the art that the invention is not limited to a VTL system and can be applied in any disk based backup system.

### B. Metadata Layout on Disk

A virtual tape comprises of portions of disk space reserved on the disk subsystem. These portions of disk space are termed as disk segments. Disk segments can be of fixed size or can be of a variable size and depends on the disk segment allocation policy employed by the VTL system.

A disk segment can be a data-segment, wherein the contents of the disk segment corresponds to the backup data received by from the backup server. The data received from the backup application is written directly to a data-segment unchanged or can be compressed using a suitable data compression algorithm before writing to the data-segment. A disk segment can also be a meta-segment which contains information maintained by a virtual tape in order to access the backup data written to the data-segment(s).

It should be noted that the disk segments needn't necessarily be from the same disk source. A disk segment can be allocated from any disk available to the virtual tape system. Disk segments are located by a combination of the “Disk ID” which is an unique number assigned to a disk and a “Block Number” which indicates a disk sector. The VTL system maintains information about the disk segments that have been allocated to virtual tapes and the disk segments that are yet to be allocated (a pool of free disk segments). Also disk segments can have multiple references where in one or more virtual tapes reference the same disk segment. A disk segment is considered to be free if the number of references to it is zero. The first time a disk segment is allocated to a virtual tape it is considered to have a reference of one.

Information about the virtual tapes created in the VTL system and the location of the first meta-segment allocated for a virtual tape would be maintained in a database accessible/maintained by the VTL system. The first meta-segment allocated for a virtual tape would contain a virtual tape descriptor block. A virtual tape can have one or more tape partitions with a single partition being most common case. A virtual tape partition is similar to a physical tape partition and is used to separate backup data. The virtual tape descriptor block contains information about each partition. Additional information related to the virtual tape can be held, such as the time the virtual tape data was exported/copied to a physical tape etc.

FIG. 2 illustrates the association between the virtual tape descriptor block (200) and a virtual tape partition (201).

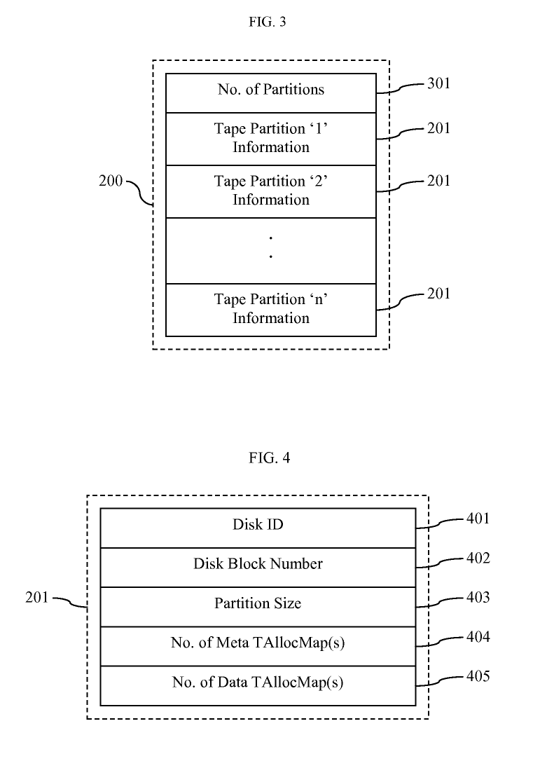

FIG. 3 illustrates the metadata layout for the virtual tape descriptor block (200).

The “No. of Partitions” field (301) contains the number of virtual tape partitions for the virtual tape.

Following the “No. of Partitions” field (301) is the virtual tape partition information (201).

The virtual tape partition metadata information (201) is illustrated in FIG. 4.

The “Disk ID” (401) and “Disk Block Number” (402) fields determine the location of the first meta-segment for the partition. This would match the first meta-segment maintained for the virtual tape in the database of the virtual tape system.

The “Partition Size” (403) field contains the size of the partition in bytes.

The “No. of Meta TAllocMap(s)” (404) field contains the number of TAllocMap(s) maintaining information about meta-segment(s).

The “No. of Data TAllocMap(s)” (405) field contains the number of TAllocMap(s) maintaining information about data-segment(s).

In the first meta-segment of the partition the first few blocks are reserved for the TAllocMap(s). The TAllocMap maintains disk segment allocation information for the virtual partition. The number of TAllocMap(s) depends on the amount of disk segment needed to represent the size of the virtual tape partition. The TAllocMap(s) are contiguous on disk with one TAllocMap following another. Each TAllocMap occupies a fixed size on disk such as 4 kilobytes of disk space. The TAllocMap(s) are divided such that the first few TAllocMap(s) contain information about the meta-segment(s) and the rest contain information about the data-segment(s). In case the space available in the meta-segment is insufficient to store all the TAllocMap(s) additional meta-segment(s) can be allocated to store the remaining TAllocMap(s).

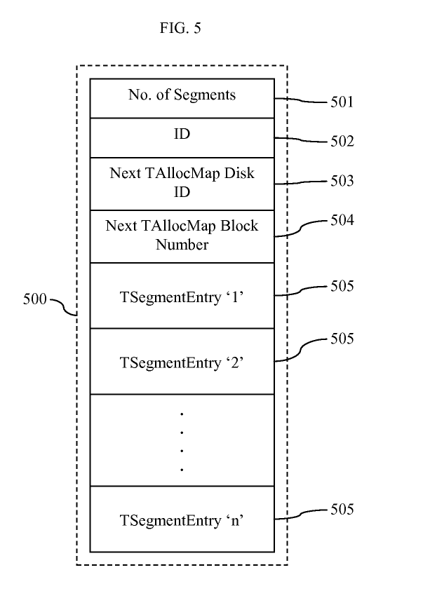

FIG. 5 illustrates the metadata layout for a TAllocMap (500).

The “No. of Segments” (501) field indicates the number of TSegmentEntry(s) in the TAllocMap.

The “ID” (502) field indicates an identifier assigned to the TAllocMap which is a unique number within the virtual tape partition.

The “Next TAllocMap Disk ID” (503) and “Next TAllocMap Block Number” (504) contain the location of the next TAllocMap. These fields are relevant if the next TAllocMap is in a different meta-segment than the TAllocMap.

Following the above fields of the TAllocMap is the TSegmentEntry(s) (505) metadata information.

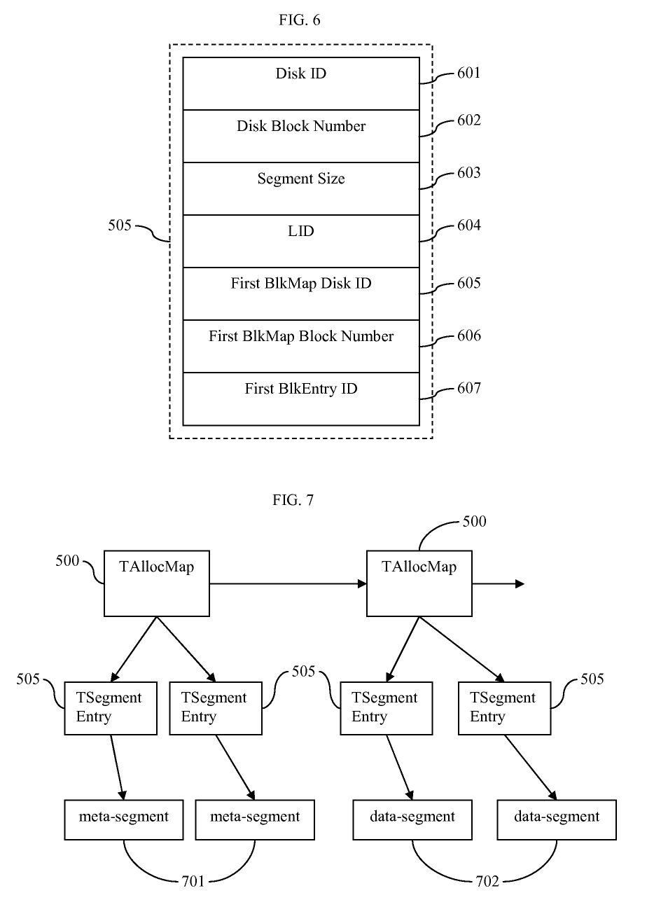

FIG. 6 illustrates the metadata layout for a TSegmentEntry (505).

The “Disk ID” (601) and “Disk Block Number” (602) together indicate the location for the disk segment.

The “Segment Size” (603) field contains the size of the disk segment allocated. In case disk segments are of the same size across all virtual tapes, this field would be insignificant.

The “LID” (604) field indicates the start logical block number of the first data block written on the disk segment. This is relevant for data-segment(s). A logical block number is the block number assigned to each data block/tape mark in the virtual tape and can differ from the physical block number (sector number) of the disk.

The “First BlkMap Disk ID” (605), “First BlkMap Block Number” (606), and “First BlkEntry ID” (607) fields together indicate the BlkMap and BlkEntry which correspond to the first data block in the disk segment. BlkMap and BlkEntry are described further below. These fields are relevant if the disk segment is a data-segment.

FIG. 7 illustrates the association between the TAllocMap(s) (500), TSegmentEntry(s) (505), meta-segment(s) (701) and data-segment(s) (702).

A write command issued by a backup application to a tape drive would contain information about the block size to be written onto disk and the number of blocks to be written. For every write command issued, the information about the data to be written is maintained by a block entry (henceforth as BlkEntry). Each BlkEntry contains information regarding the size of the block written to disk, the number of blocks written to disk, and the compressed data size if the data were compressed before writing to disk.

The information of BlkEntry(s) is maintained by a BlkMap. Each BlkMap would contain a header which holds information such as the number of BlkEntry(s) it maintains, the location of the next BlkMap etc. Following the BlkMap header would the BlkEntry(s) information.

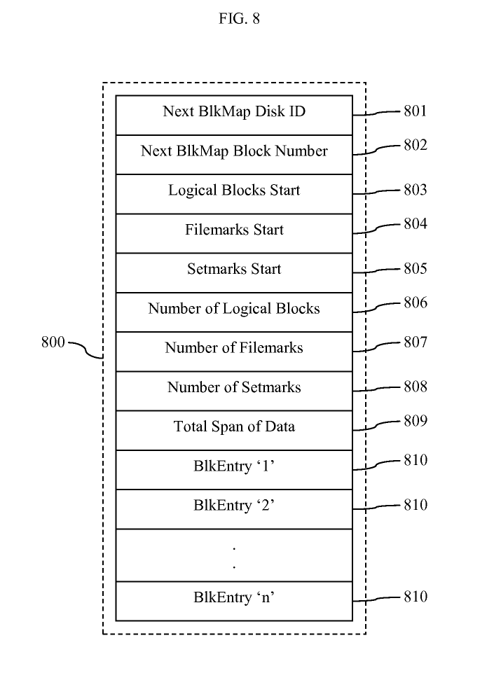

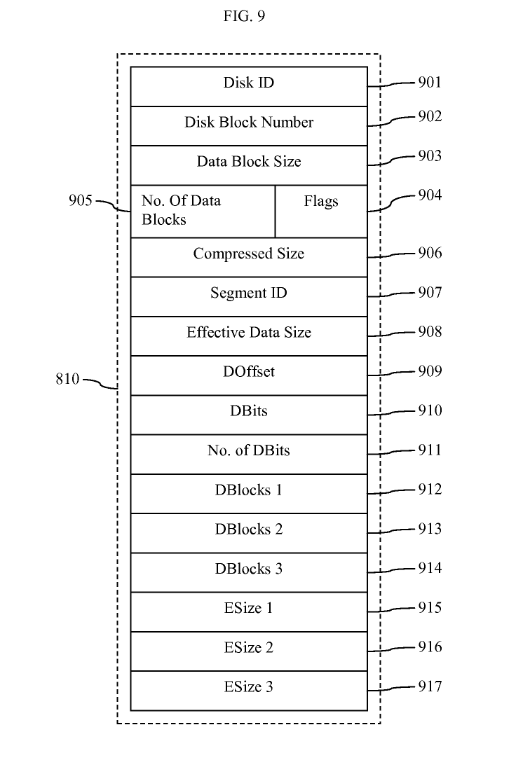

FIG. 8 illustrates the metadata layout for a BlkMap (800). Each BlkMap (800) is of a fixed size such as 4 kilobytes of disk space. A BlkMap contains a header followed by the BlkEntry(s) (810).

The location of the next BlkMap is determined by the “Next BlkMap Disk ID” (801) and “Next BlkMap Block Number” (802) fields.

The “Logical Blocks Start” (803), “Filemarks Start” (804) and “Setmarks Start” (805) indicate the number of Logical Blocks, Filemarks and Setmarks respectively that were written to the virtual tape before this BlkMap. This field is used locating data blocks or tape marks.

The “Number of Logical Blocks” (806), “Number of Filemarks” (807) and “Number of Setmarks” (808) fields indicate the number of Logical Blocks, Filemarks and Setmarks written for the BlkEntry(s) maintained by the BlkMap.

The “Total Span of Data” (809) field indicates the total amount of data covered by the BlkEntry(s) (810) in the BlkMap.

FIG. 9 illustrates the metadata layout for a BlkEntry (810).

The “Disk ID” (901) and “Disk Block Number” (902) fields correspond to the start location of the span of data referenced by the BlkEntry.

The “Data Block Size” (903) field corresponds to the size of each data block.

The “Flags” (904) field maintains additional information regarding the type of the BlkEntry. The information in the Flags filed would indicate one of the following
a. The BlkEntry corresponds to uncompressed data.
b. The BlkEntry corresponds to compressed data.
c. The BlkEntry corresponds to a Filemark.
d. The BlkEntry corresponds to a Setmark.

The “No. Of Data Blocks” (905) field corresponds to the number of the data blocks corresponding to the BlkEntry. In case the BlkEntry corresponds to a Filemark or Setmark, then the “No. of Data Blocks” (905) field corresponds to the number of Filemarks or Setmarks requested for in a single WRITE FILEMARKS command (In the SCSI standard a WRITE FILEMARKS command is sent to write Filemarks or Setmarks). The “Data Block Size” (903) and “Compressed Size” (906) fields are irrelevant in such a case. If command received is a WRITE command (In the SCSI standard a WRITE command is sent to write the data itself) then multiple BlkEntry(s) are used to represent each logical block of data specified in the command and the “No. of Data Blocks” (905) field would contain a value of “1”.

The “Compressed Size” (906) field contains the total size of the compressed data if the span of data the BlkEntry corresponds were compressed prior to writing to disk.

The “Effective Data Size” (908) field is relevant when the BlkEntry corresponds to a data block. The “Effective Data Size” (908) is the total data span referenced by the BlkEntry and can be less than the span referenced by the “Data Block Size” (903) field. For example if the original WRITE command specified a data block of size 64 kilobytes, the “Effective Data Size” might be 4 kilobytes and hence 16 BlkEntry(s) are required to represent the data block of size 64 kilobytes. The reason for such an arrangement is that within the 64 kilobytes of the logical data block some 4 kilobyte blocks can be deduplicated while the rest cannot. An example of such a scenario is when the single 64 kilobytes block might actually contain file and file data information for two or more files.

The “Segment ID” (907) field tracks the data-segment corresponding to the span of data referenced by the BlkEntry. The “Segment ID” is a combination of the TAllocMap “ID” and the TSegmentEntry “ID” within the TAllocMap.

The “DOffset” (909), “DBits” (910), “No. of DBits” (911), “DBlocks 1” (912), “DBlocks 2” (913), “DBlocks 3” (914), “ESize 1” (915), “ESize 2” (916) and “ESize 3” (917) fields are used if the BlkEntry is modified to reference a different span of data as a result of data deduplication and is further described later.

Information regarding the BlkMap(s) created in a virtual tape partition is available via the MapLookup(s). MapLookup(s) provide a fast and efficient approach to locate a particular BlkMap.

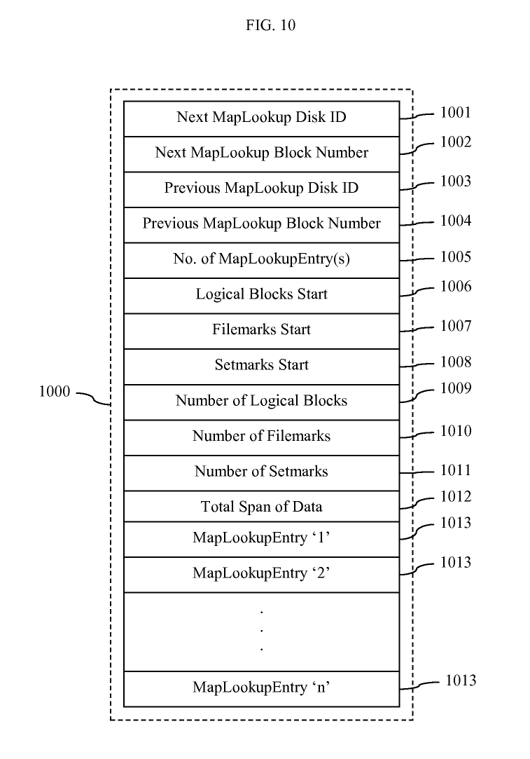

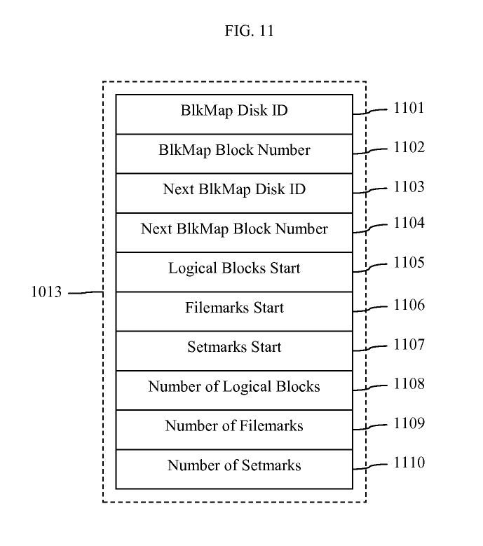

FIG. 10 illustrates the metadata layout for a MapLookup (1000). Each MapLookup (1000) occupies a fixed size on disk such as 4 kilobytes of disk space. A MapLookup (1000) contains a header followed by the MapLookupEntry(s) (1013).

The “Next MapLookup Disk ID” (1001) and “Next MapLookup Block Number” (1002) fields indicate the location of the next MapLookup.

The “Previous MapLookup Disk ID” (1003) and “Previous MapLookup Block Number” (1004) fields indicate the location of the previous MapLookup.

The “No. of MapLookupEntry(s)” (1005) field contains the number of MapLookupEntry(s) present in the MapLookup.

The “Logical Blocks Start” (1006), “Filemarks Start” (1007) and “Setmarks Start” (1008) fields indicate the number of Logical Blocks, Filemarks and Setmarks respectively that were written to the virtual tape before this MapLookup. This field is used locating data blocks or tape marks.

The “Number of Logical Blocks” (1009), “Number of Filemarks” (1010) and “Number of Setmarks” (1011) fields indicate the number of Logical Blocks, Filemarks and Setmarks written by the BlkMap(s) which are referenced by the MapLookupEntry(s) in the MapLookup.

The “Total Span of Data” (1012) field indicates the total amount of data covered by the BlkMap(s) which are referenced by the MapLookupEntry(s) in the MapLookup.

The MapLookupEntry(s) (1013) immediately follow the MapLookup header. FIG. 11 illustrates the metadata layout of a MapLookupEntry (1013). The MapLookupEntry (1013) is similar to the header information maintained by the BlkMap. Redundancy of information is present in the MapLookupEntry and in the BlkMap header for detecting metadata corruption. Also redundancy of the information ensures that a BlkMap needn't be loaded from disk to determine whether a BlkMap can locate a given data block.

The “BlkMap Disk ID” (1101) and “BlkMap Block Number” (1102) indicate the location of the BlkMap the MapLookupEntry corresponds to.

The “Next BlkMap Disk ID” (1103) and “Next BlkMap Block Number” (1104) indicate the location of the next BlkMap.

The “Logical Blocks Start” (1105), “Filemarks Start” (1106) and “Setmarks Start” (1107) indicate the number of Logical Blocks, Filemarks and Setmarks respectively that were written to the virtual tape before the BlkMap the MapLookupEntry corresponds to. This field is used locating data blocks or tape marks.

The “Number of Logical Blocks” (1108), “Number of Filemarks” (1109), “Number of Setmarks” (1110) fields indicate the number of Logical Blocks, Filemarks and Setmarks written for the BlkEntry(s) maintained by the BlkMap the MapLookupEntry corresponds to.

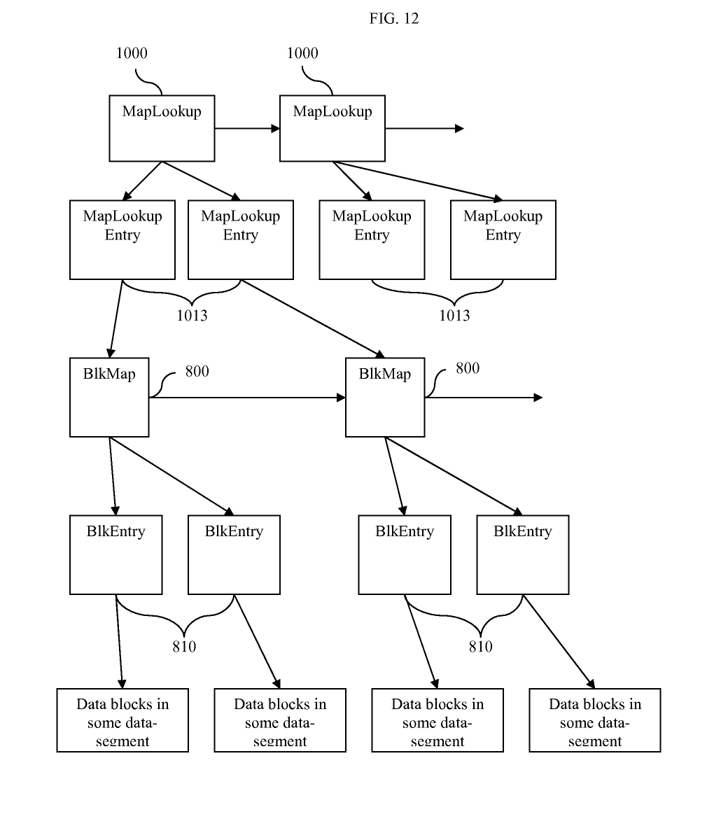

FIG. 12 illustrates the association between MapLookup(s) (1000), MapLookupEntry(s) (1013), BlkMap(s) (800) and BlkEntry(s) (810).

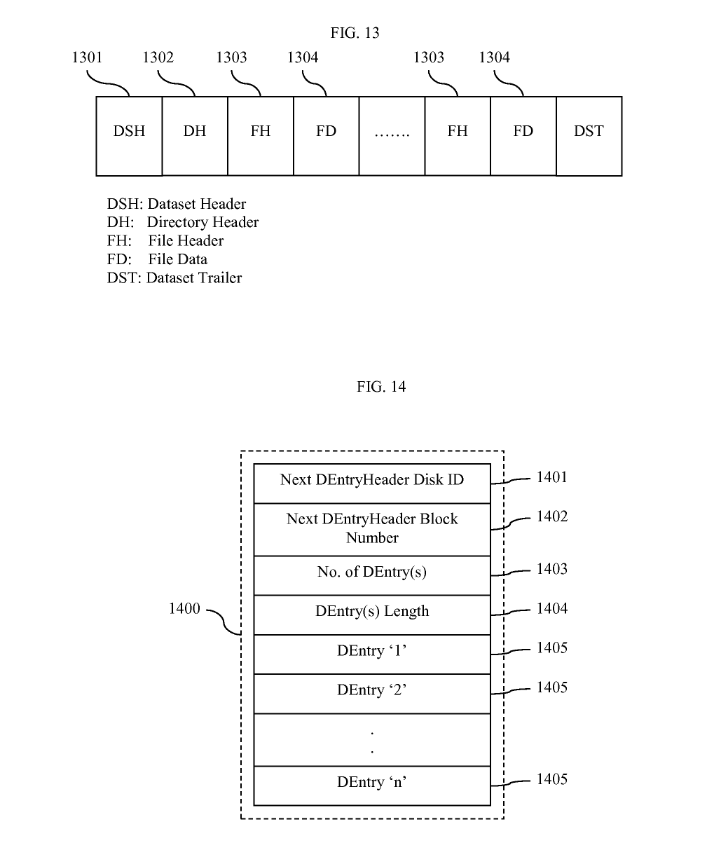

FIG. 13 illustrates an example layout of a backup data set. A backup data set can comprise of information such as a dataset header (1301) which contains information about the dataset, directory header (1302) which contains information about a directory being backed up, file header (1303) which contains information about a file being backed up and then followed by the file data (1304) itself. The format of the backup data set depends of the format employed by the backup application. In case the backup dataset format is understood by the virtual tape system, the backup dataset received is parsed by a relevant dataset parser. Each backup dataset is parsed for directories and files. Usually an end of a backup set is indicated by the backup application by sending a WRITE FILEMARK SCSI command.

Every new dataset being backed up would be assigned a new dataset id and the time at which the dataset was received is tracked.

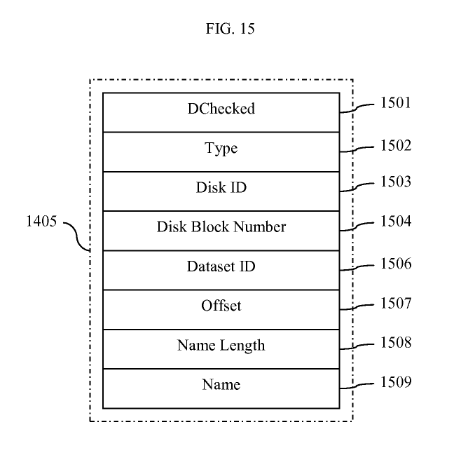

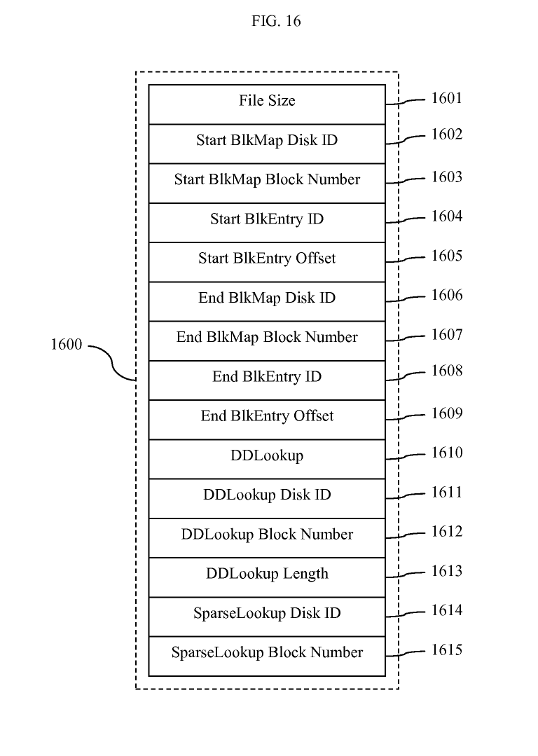

For every directory information encountered in the backup dataset information about that directory is stored in a DEntryHeader block (1400) as illustrated in FIG. 14. A DEntryHeader block (1400) is of a fixed size such as 4 kilobytes of disk space. For every file or subdirectory encountered which belongs to the directory a DEntry structure (1405) is maintained as illustrated in the FIG. 15. Information about the file itself is maintained in a FEntry structure as illustrated in FIG. 16. Thus from a DEntryHeader (1400) block, information about the subdirectories and files in a directory can be retrieved from the DEntry structures (1405). In case of a file from its DEntry additional information about the file is obtained from its corresponding FEntry.

As illustrated in FIG. 14 for a DEntryHeader.

The “Next DEntryHeader ID” (1401) and “Next DEntryHeader Block Number” (1402) fields indicate the location of the next DEntryHeader block for the directory. A directory can have multiple DEntryHeader(s) if the information of all the subdirectories and files (the DEntry(s)) do not fit into a single DEntryHeader.

The “No. of DEntry(s)” (1403) field contains the number of DEntry(s) contained in the DEntryHeader block.

The “DEntry(s) Length” (1404) field contains the total length in bytes of all the DEntry(s) in the DEntryHeader block.

The DEntry(s) (1405) information follows the “DEntry(s) Length” field.

FIG. 15 illustrates the metadata layout of a DEntry (1405).

The “Type” (1502) field indicates the type of the DEntry. Type can be a File or a directory (a subdirectory). In case of a directory the “Disk ID” (1503) and “Disk Block Number” (1504) fields indicate the location of the corresponding DEntryHeader on disk. In case of a file the “Disk ID” (1503) and “Disk Block Number” (1504) fields indicate the location of the corresponding FEntry on disk.

The “DChecked” (1501) field indicates whether the DEntry has been checked by the data deduplication operation.

The “Dataset ID” (1506) contains the unique ID assigned to backup dataset the DEntry belongs to.

The “Offset” (1507) field is used if the DEntry corresponds to a File. FEntry structures need not necessarily be located at the start of a disk sector block so that FEntry structures can be packed in a disk block. The offset field indicates the byte offset from a disk block to obtain the FEntry structure. In case the DEntry corresponds to a directory, this field is unused.

The “Name” (1509) field indicates the name of the directory or file.

The “Name Length” (1508) field indicates the length of the name.

FIG. 16 illustrates the metadata layout for a FEntry (1600).

The “File Size” (1601) field indicates the file's size in bytes.

The “Start BlkMap Disk ID” (1602) and “Start BlkMap Block Number” (1603) fields together indicate the location of the BlkMap corresponding to the start of the file data.

The “Start BlkEntry ID” (1604) field corresponds to the entry id within the Start BlkMap which corresponds to the start of the file data.

Likewise the “End BlkMap Disk ID” (1606), “End BlkMap Block Number” (1607) and “End BlkEntry ID” (1608) give information about the BlkMap and BlkEntry which correspond to the end of the file data.

The “Start BlkEntry Offset” (1605) corresponds to the offset within the data span information maintained by the start BlkEntry which indicates the start of the file data. Like wise the “End BlkEntry Offset” (1609) indicates the end of the file data within the data span information maintained by the BlkEntry.

Thus given the BlkMap(s) and BlkEntry(s) information, data corresponding to a file can be accessed.

The “Sparse Lookup Disk ID” (1614) and “Sparse Lookup Block Number” (1615) indicate the location of the SparseLookup block for the file. In case the file is not a sparse file, the values are zero in these fields. A sparse file is on wherein there are gaps between the file data. These gaps are generally treated as a sequence of zeros, but the gap bytes themselves are not backed up. The dataset usually contains information about the non sparse file data segments in the file header information or file segment header information.

The fingerprint computed for the file data is stored in the “DDLookup” structure (1610) (described further below). If the file size is large and multiple DDLookup(s) are needed, then the DDLookup(s) are stored on a separate disk block and the “DDLookup Disk ID” (1611), “DDLookup Block Number” (1612) and “DDLookup Length” (1613) indicate the location of the block.

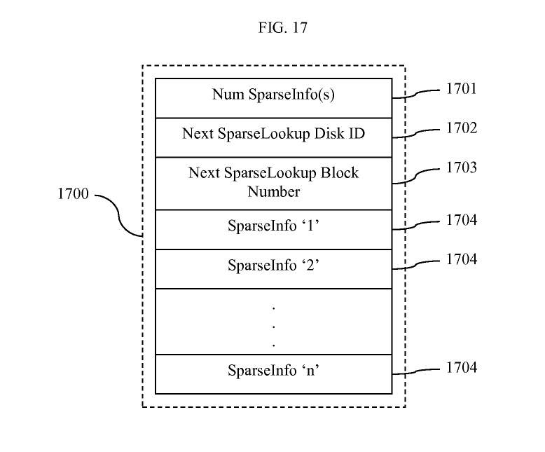

The SparseLookup (1700) block maintains information about the non sparse file segments as illustrated in FIG. 17.

The “Num SparseInfo(s)” (1701) field indicates the number of SparseInfo(s) (1704) structures in the SparseLookup block.

In case the number of SparseInfo(s) (1704) required are many, multiple SparseLookup blocks would be needed. The location of the next SparseLookup block is indicated by the “Next SparseLookup Disk ID” (1702) and “Next SparseLookup Block Number” (1703) fields Following the “Next SparseLookup Block Number” (1703) field are the SparseInfo structures (1704).

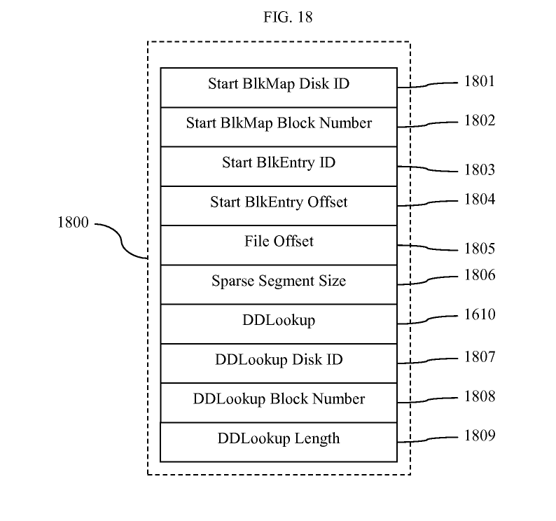

FIG. 18 illustrates the metadata layout of a SparseInfo structure (1704). The SparseInfo (1704) structure is similar to the FEntry (1600) structure. Each SparseInfo (1704) maintains information about a non sparse file segment. The fingerprint computed for the sparse file segment is stored in the “DDLookup” structure (1610) (described further below) of the SparseInfo. If the sparse file segment is large and multiple DDLookup(s) are needed, then the DDLookup(s) are stored on a separate disk block and the “DDLookup Disk ID” (1807), “DDLookup Block Number” (1808) and “DDLookup Length” (1809) indicate the location of the block.

The “File Offset” (1805) field indicates the offset of the file data the sparse file segment corresponds to.

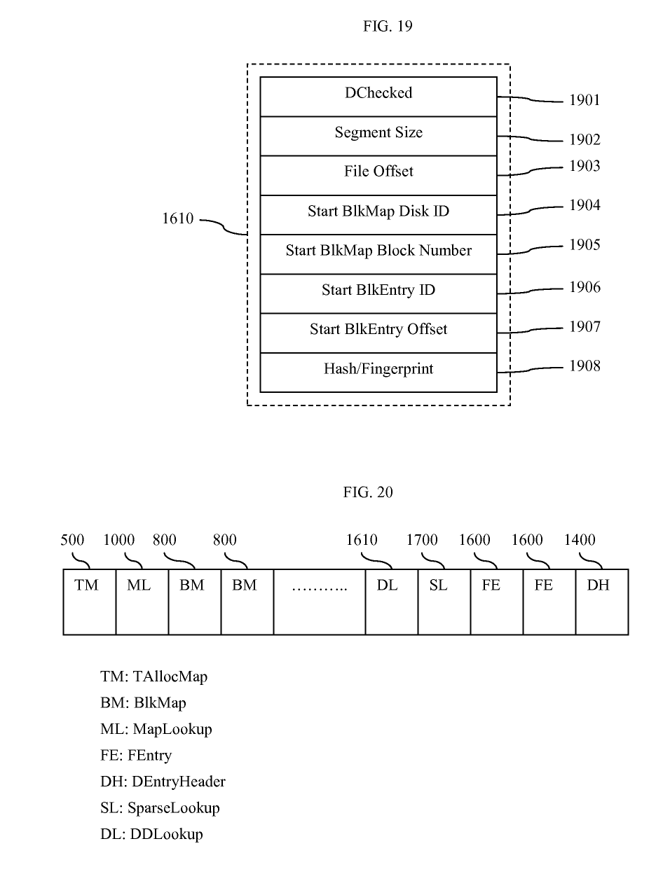

FIG. 19 illustrates the metadata layout of a DDLookup structure (1610).

The DDLookup structure contains information regarding the location of a file segment (or a sparse file segment) and the fingerprint for the file segment. File data can be broken down into multiple segments and the fingerprint computed for the file segments rather than for the whole file. The reason for this is that if the fingerprint is computed for the entire file and the next time the same file were to be backed up but only a single byte were changed, the entire file would be considered to have changed. If the file data was broken down to multiple segments the probability of the fingerprint for a file segment matching the fingerprint for a file segment from a previous dataset is higher.

The “Segment Size” (1902 indicates the size of the file segment for which the fingerprint has been computed. In case the fingerprint is for the entire file data the segment size is equal to the file size.

The “File Offset” (1903) indicates the offset within the file data from where in the file segment starts. In case the fingerprint is computed for the entire file data, this field contains a zero value.

The “Start BlkMap Disk ID” (1904), “Start BlkMap Block Number” (1905), “Start BlkEntry ID” (1906), “Start BlkEntry Offset” (1907) indicate the location of the file segment data.

The “Hash/Fingerprint” (1908) field contains the fingerprint computed for the file segment data.

The DDLookup (1610) information is maintained as a part of the FEntry structure (1600) itself if the fingerprint is computed for the entire file data. Else the DDLookup information is maintained in a separate disk block as indicated by the “DDLookup Disk ID” and “DDLookup Block Number” fields.

FIG. 20 illustrates the layout of TAllocMap(s) (500), BlkMap(s) (800), MapLookup(s) (1000), DEntryHeader(s) (1400), FEntry(s) (1600), SparseLookup(s) (1700) and DDLookup(s) (1610) in a meta-segment. The DEntryHeader(s), FEntry(s) (1600), SparseLookup(s) (1700) and DDLookup(s) (1610) which are related to the file and directory information in a dataset are stored at the end of a meta-segment moving towards the beginning while the rest which are related to the data blocks of the dataset are stored at the start of a meta-segment moving towards the end.

Every virtual tape would have a root directory and the DEntryHeader for the root director is at the tail end of the first meta-segment. The root DEntryHeader For every new backup dataset a DEntry is added to the root DEntryHeader, the “Name” field in the DEntry header would contain the current time of the system as a textual string. The time would usually be the number of seconds since a certain epoch such as UTC epoch. This DEntry is referred to as the “Dataset Time” DEntry and is the dataset directory for a backup dataset. The DEntryHeader corresponding to the “Dataset Time” DEntry would now contain the directories and file DEntry(s) for the files and directories parsed from the dataset. The advantage of the “Dataset Time” DEntry is that it would provide an indication of when the backup itself was made and also separate directory and file information between datasets.

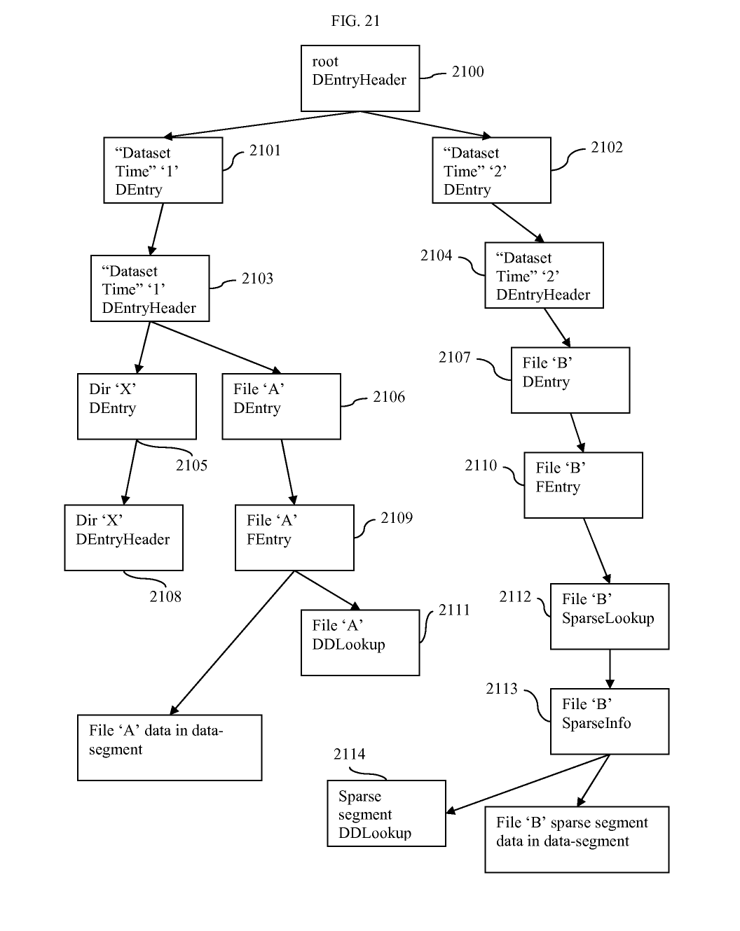

FIG. 21 illustrates an example relationship between DEntryHeader, DEntry, FEntry, DDLookup, SparseLookup and the data blocks. In the example the root DEntryHeader (2100) of the virtual tape partition has information of two datasets for which the corresponding “Dataset Time” DEntry(s) are (2101) and (2102). The DEntryHeader (2103) corresponding to “Dataset Time” “1” DEntry (2101) has information of two DEntry(s), Dir “X” DEntry (2105) which corresponds to a directory (DEntry (2105) and DEntryHeader (2108) and File “A” DEntry (2106) which corresponds to a file (FEntry (2106). FEntry (2106) maintains information about the file data fingerprint information in DDLookup (2111)) and also maintains information about the location of the file data. Similarly DEntryHeader (2104) has information of a single file DEntry (2107) which corresponds to FEntry (2110) and since it is a sparse file the FEntry (2110) maintains information about SparseLookup (2112). SparseLookup (2112) maintains information about the sparse file segments in SparseInfo(s). FIG. 21 illustrates a sparse file with a single sparse segment, the information of is maintained by SparseInfo (2113). The SparseInfo (2113) maintains fingerprint information of sparse segment file data in DDLookup (2114) and also maintains information about the location of the sparse segment data.

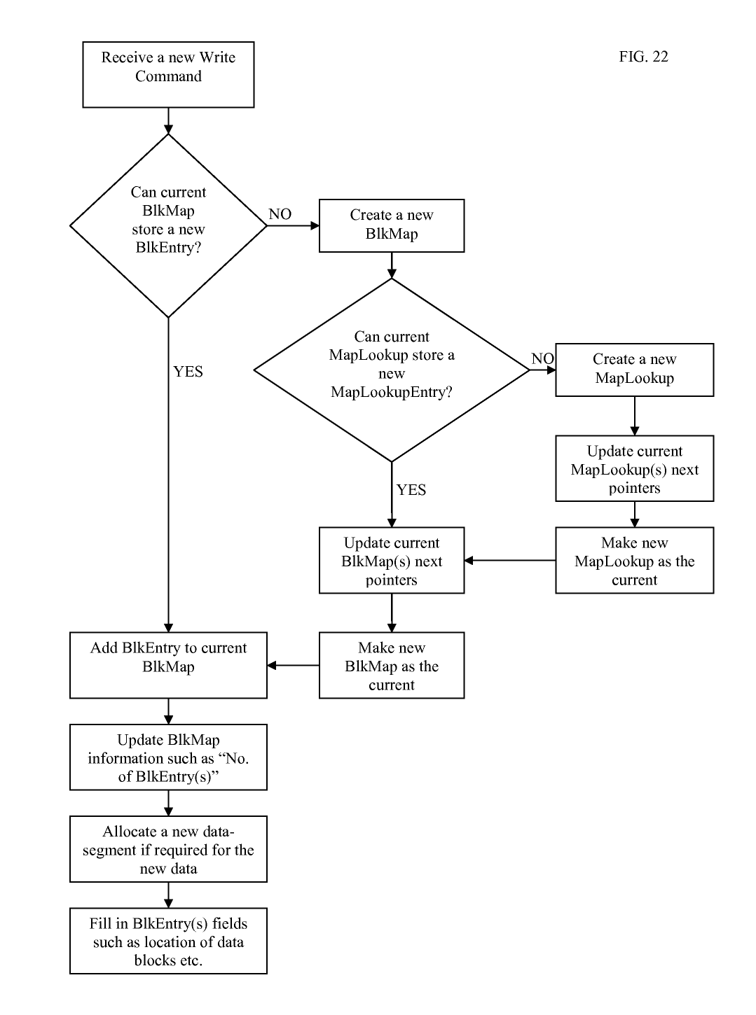

FIG. 22 illustrates the logic for creating the metadata for a new Write command. It should be noted that FIG. 22 illustrates a minimalist logic and is only for better understating of the BlkMap(s), MapLookup(s) and BlkEntry(s) etc and their relation. An implementation would have to perform additional error checks, and the order in which the checks for creating a new BlkMap, BlkEntry etc are dependent on the implementation.

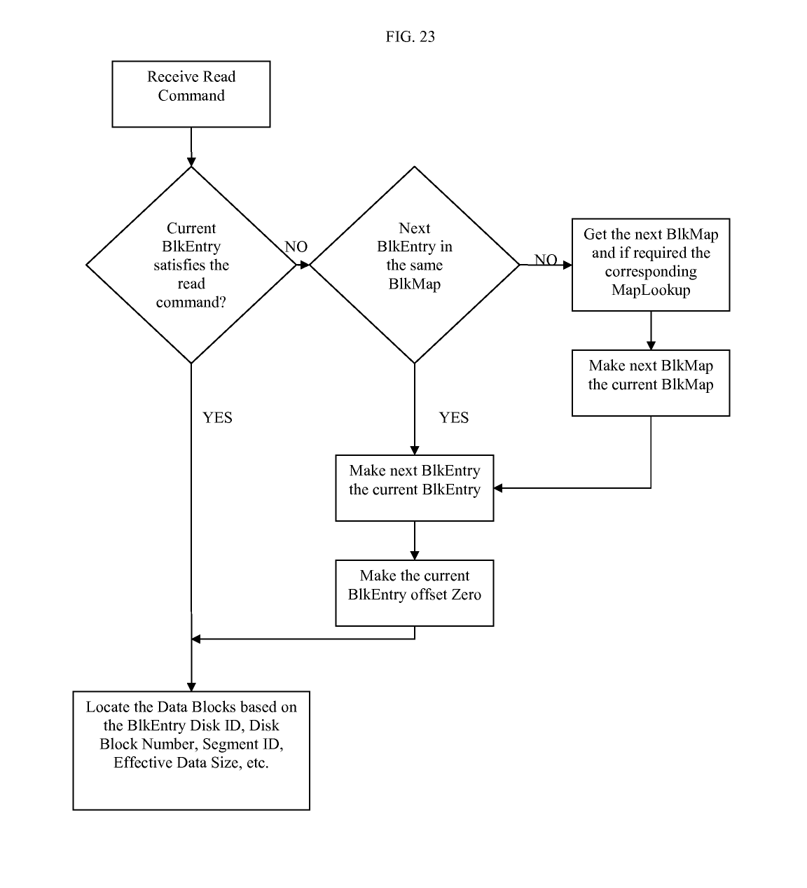

Likewise FIG. 23 illustrates the logic for reading a data block based on the current BlkEntry, BlkMap etc. The current BlkMap, BlkEntry etc. would correspond to the BlkMap and BlkEntry which should be referred to for reading the next data block from disk. It should be noted again that FIG. 23 is only a minimalist logic only for better understanding how a data block is retrieved using the information from a BlkMap, BlkEntry, MapLookup etc. Also the logic illustrates that a single BlkEntry can satisfy a READ command request. However to satisfy a READ request multiple BlkEntry(s) may be required based on the Effective Data Size of the BlkEntry and the required data size of the READ command.

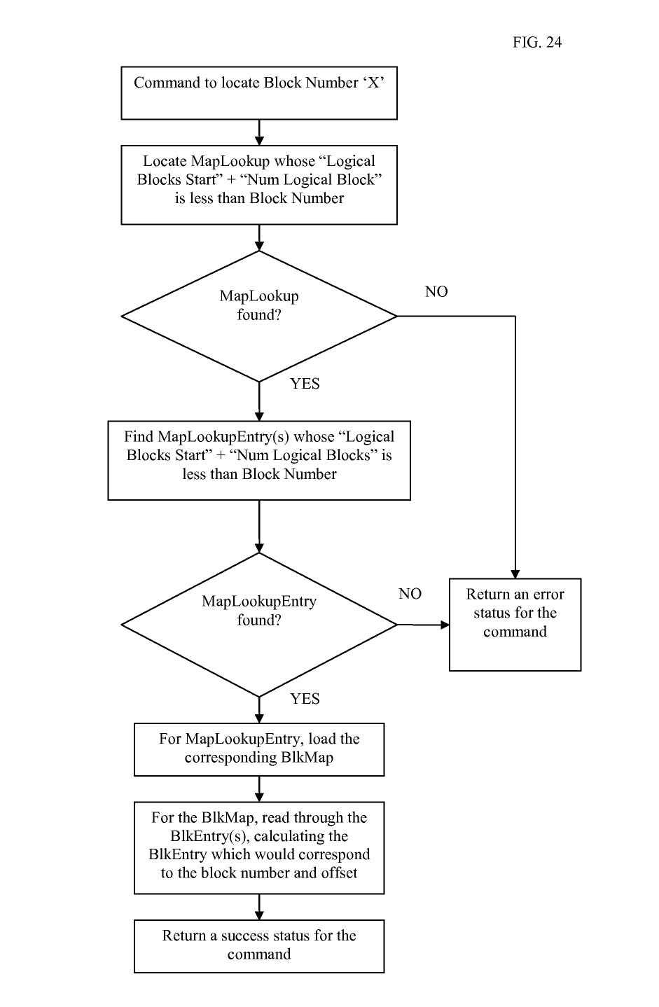

FIG. 24 illustrates the logic required in locating a data block or tape mark on disk. The “Logical Blocks Start”, “No. of Logical Blocks” fields in the MapLookup and its corresponding MapLookupEntry(s) help in a fast lookup for the needed BlkMap. Once the BlkMap needed is obtained, examining its BlkEntry(s) would give the location of the required Logical Block. Similar logic can be applied for locating any Filemark or Setmark. It should be noted that FIG. 24 is only a minimalist logic and only illustrates how the MapLookup, MapLookupEntry, BlkMap etc are used to locate a block

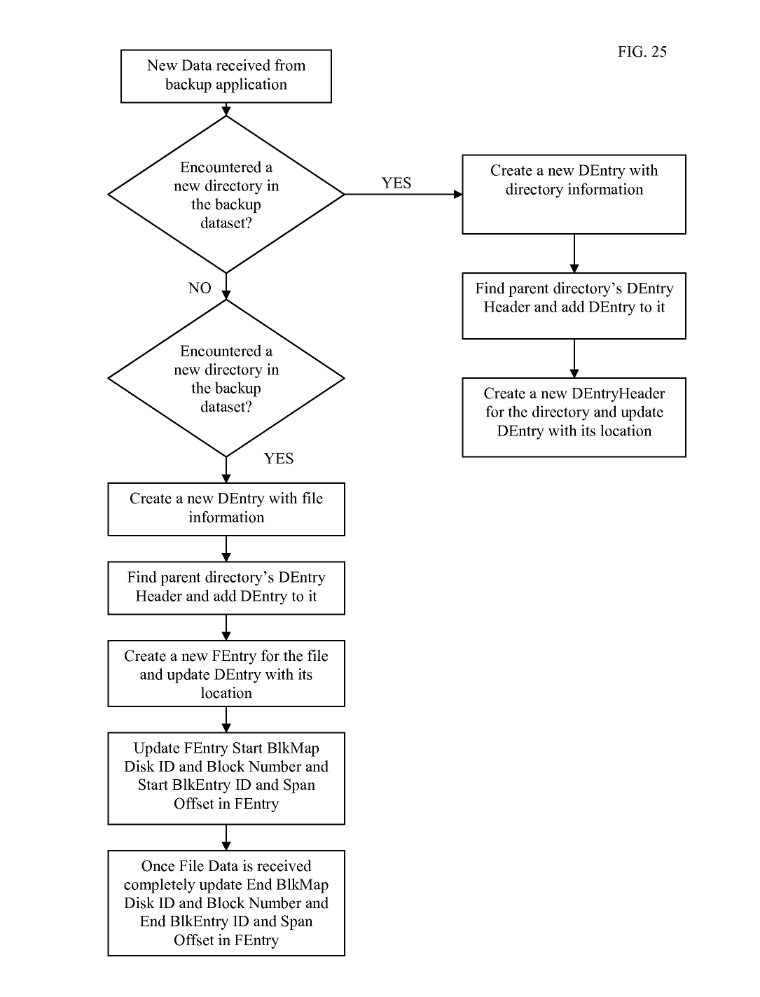

FIG. 25 illustrates the logic of parsing a data stream when new data blocks are received to be written to disk.

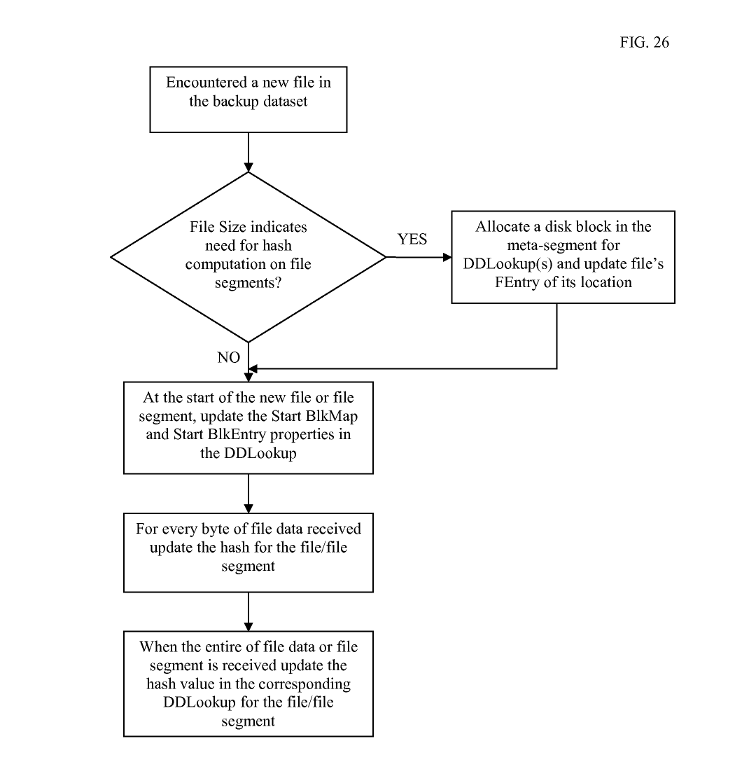

FIG. 26 illustrates the logic for generating fingerprint(s) and updating a file's FEntry with the fingerprint information.

### C. Deduplication Operation

The deduplication operation commences at a suitable time after a backup dataset has been written to disk. A suitable time can be a time scheduled by the operator, or when no backups are being performed to the system etc. The deduplication operation can also be manually commenced by an operator. Also the deduplication operation can be stopped at any point either by an operator or as determined by the system.

The deduplication module begins the operation by reading from disk the root DEntryHeader for each virtual tape in a VTL instance. The “Dataset Time” DEntry(s) information is then read from the root DEntryHeader. From the “Dataset Time” DEntry(s) information about the directories, files etc. for each backup dataset can be obtained. For any given DEntry if the “DChecked” field has a value of “1” it would indicate that the data deduplication check has already been performed for that DEntry and the corresponding file/directory can be skipped. For example if the DEntry corresponds to a directory and for that directory the deduplication check has already been performed, all subdirectories and files for the directory can be skipped.

If the deduplication check needs to be performed on a DEntry of type directory, the DEntryHeader for the directory is read and the DEntry(s) in the DEntryHeader are examined, till all subdirectories and files are checked.

If the deduplication check needs to be performed and if the DEntry corresponds to a file then a lookup for the file with an identical traversal path is searched for in all previous “Dataset Time” DEntry(s). A previous “Dataset Time” DEntry is one whose dataset time is lesser than the current “Dataset Time” DEntry. The dataset time can be retrieved from the name of the “Dataset Time” DEntry. There could be multiple previous DEntry(s) corresponding to the same current path. The DEntry corresponding to a higher dataset time among all previous DEntry(s) is considered first.

A traversal path between two file DEntry(s) is identical when starting from below the “Dataset Time” DEntry(s), the “Name” field of the DEntry(s) traversed to reach the two file DEntry(s) match (names can be case sensitive depending on the backup format used to store the dataset) and should also correspond to directories. The “Name” filed of the file DEntry(s) themselves should match. The “Name” field in the “Dataset Time” DEntry corresponding two the paths would differ. The root DEntryHeader for the two paths might differ if the DEntry(s) belongs to different virtual tapes.

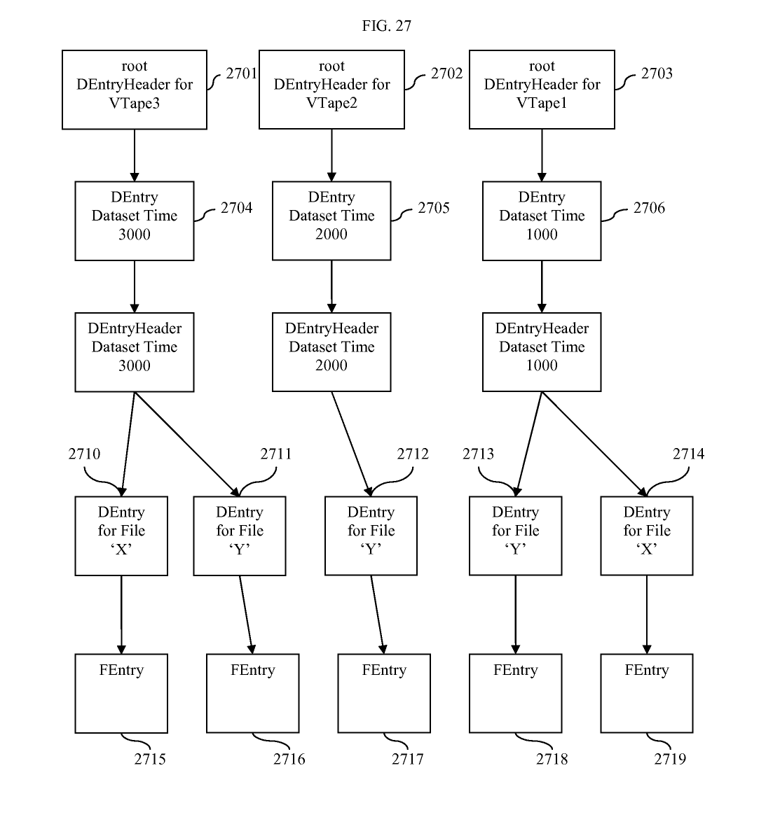

For example in FIG. 27 three root DEntryHeader(s) are illustrated ((2701), (2702) and (2703)).

If the data deduplication check is being performed for file ‘Y’ (DEntry (2711) and FEntry(2716)) in VTape3 (Virtual Tape 3) then previous file to be used for data deduplication check would be file ‘Y’ (DEntry (2712) and FEntry (2717)) in VTape2 (Virtual Tape 2) since it would have an identical traversal path and the “Dataset Time” DEntry has a value of 2000 (from DEntry (2705)) which is lesser than the current “Dataset Time” DEntry value of 3000 (from DEntry (2704)). It should be noted that even though file ‘Y’ (DEntry (2713) and FEntry (2718)) has the same traversal path in VTape1 (Virtual Tape 1) its “Dataset Time” value is 1000 (from DEntry (2706)) is lesser than the “Dataset Time” value of 2000 (from DEntry (2705)). Similarly if the data deduplication check is being performed for file ‘Y’ in VTape2 (DEntry (2712) and FEntry (2717)) then the previous file to be considered would be file ‘Y’ (DEntry (2713) and FEntry (2718)) in VTape1.

If the data deduplication check is being performed for file ‘Y’ (DEntry (2713) and FEntry (2718)) in VTape1 then there wouldn't be a previous file to perform the check against. If the data deduplication check is being performed for file ‘X’ (DEntry (2710) and FEntry (2715)) in VTape3 then the previous file to be considered would be file ‘X’ (DEntry (2714) and FEntry (2719)) in VTape1. An exception to the above illustrated examples would be when the file data were to spread across multiple tapes in the case of tape spanning. Tape spanning occurs when a dataset spans more than one tape. In the case of tape spanning there would be multiple previous identical paths with the same “Dataset Time” DEntry. In such a case depending on the offset of the file segment data in the file, the appropriate previous DEntry for the file is considered.

It should be noted that the examples given above are only a few and should not be considered exhaustive. Since a directory usually can have multiple files, a list of peer directories (corresponding directories in previous datasets) can be built for a directory DEntry to speed up the traversal of paths for previous file lookups.

The DDLookup information for the current file and the previous file are compared. If the fingerprint for a file segment in the current file is identical with the fingerprint information for the corresponding previous file segment, then the data corresponding to the current file segment can be removed and instead reference the previous file segment data. Additionally the data contained in the file segments can now be matched byte per byte to ensure that the data is identical.

The process of referencing data blocks from a previous file segment data involves the following steps
1. Information about the previous data-segment is added in an unused TSegmentEntry available in a TAllocMap corresponding to data-segment(s). A reference to the previous data-segment is added for the virtual tape. If information about the previous data-segment has already been added this step is skipped
2. From the DDLookup information the “Start BlkMap” and “Start BlkEntry” information is retrieved for the current file segment and previous file segment
3. Given the “Start BlkEntry”, till the entire span of the file segment has been covered, for each of the corresponding BlkEntry, the disk “Block Number” and “Disk ID” are modified to correspond to the disk “Block Number” and “Disk ID” of the corresponding BlkEntry from the previous file segment and the “Segment ID” for each BlkEntry is modified to indicate the location of the TSegmentEntry and TAllocMap which contain information about the previous data-segment

A data-segment can correspond to multiple file segments for a plurality of files. Not all file segments within a data-segment might have a fingerprint match with a corresponding file segment in a previous dataset. Also the data-segment might have other data from the dataset not belonging to file segment data such as file header information, directory information etc. As a result not all data within the data-segment can be deduplicated. In such a scenario a new data-segment is allocated from the disk subsystem and data that cannot be deduplicated are copied to the newly allocated data-segment.

The process of copying the non deduplicated blocks to a new data-segment comprises of:
1. Allocating a new data-segment from the disk subsystem.
2. Adding information about the new data-segment in an unused TSegmentEntry from a TAllocMap corresponding to data-segment(s).
3. For all BlkEntry(s) corresponding to non deduplicated blocks in the data-segment, copying the data from the old data-segment to the new data-segment, modifying the disk “Block Number” and “Disk ID” to the start of the location in the new data-segment where the span of data referenced by the BlkEntry were copied and updating the “Segment ID” for each BlkEntry to indicate the location of the TSegmentEntry and TAllocMap of the new data-segment.

It should be noted that during the data deduplication operation, data from multiple data-segments can be copied to a single new data-segment to save disk space.

Once the BlkEntry(s) corresponding to a data-segment are either modified to correspond to data in a previous data-segment or a newly allocated data-segment, the data-segment can be released back to the disk segment allocation module. This involves releasing a reference to the disk segment the data-segment corresponds to by the virtual tape.

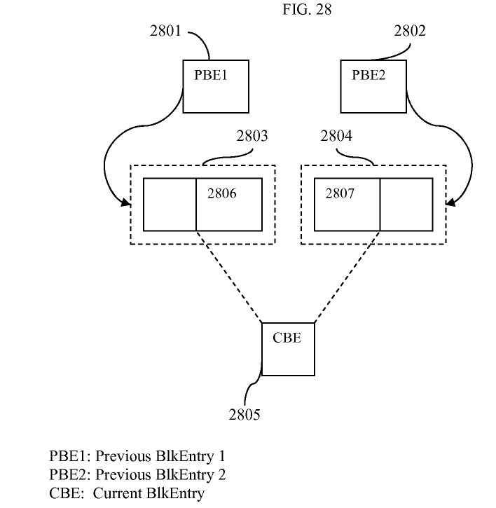

Due to changes in the data of a dataset from a previous dataset, although the fingerprint of a file segment is identical with that of file segment from a previous dataset, the DDLookup(s) corresponding to the two file segments can indicate a different “Start BlkEntry Offset”. In such a case the span of data corresponding to a BlkEntry(s) that needs to be deduplicated can match with a data span that starts with one BlkEntry and ends with another BlkEntry in the previous dataset. FIG. 28 illustrates BlkEntry (2805) for which the span of data the BlkEntry references to is identical with the data in a previous data-segment ((2806) and (2807)). However information about the corresponding span of data is distributed across two BlkEntry(s) ((2801) and (2802)). The span of data corresponding to BlkEntry (2805) is identical with the data span in the previous data-segment starting at offset within the span of data (2803) the BlkEntry (2801) corresponds to.

Information about all the corresponding BlkEntry(s) can be incorporated in to the single BlkEntry as follows:
1. The “DOffset” field indicates the offset of the start of the data span from the data span of the first previous BlkEntry.
2. The “No. of DBits” would indicate the number of previous BlkEntry(s) that cover the data span needed.
3. The “DBits” indicates if the span of data corresponding to a BlkEntry is compressed or uncompressed. A value of “1” indicates that the span of data is compressed.
4. Following this information is information about the data span of the previous BlkEntry(s). The number of these entries is fixed at 3 in order that the size of the BlkEntry metadata structure is of a fixed size.
5. The “ESize 1” field indicates the effective size of the first previous BlkEntry, “ESize 2” field indicates the effective size of the next previous BlkEntry etc.
6. The “DBlocks 1” fields indicates the number of 512 byte sized blocks the data span corresponding to the BlkEntry occupies on disk. If the blocks on disk were compressed, the “DBits” field corresponding to the BlkEntry is set to “1” else it is set to “0”.

A data-segment that has blocks that can be deduplicated needn't necessarily be deduplicated. For example if the amount of data that can be deduplicated is far too less than amount of data that cannot be deduplicated, the VTL system might choose not to deduplicate the data in the data-segment. In such a case no modification to the BlkEntry(s) are made or changes that were made related to the data-segment are reverted.

In order to access the data referenced by a BlkEntry which has been deduplicated and corresponds to data from multiple BlkEntry(s) the VTL system does the following
1. The “No. of Bits” field would indicate the number of previous BlkEntry information that has been incorporated.
2. Based on the “No. of DBits” field the system computes the sum of “DBlocks 1”, “DBlocks 2” etc. For example if the “DBits” field value is two one only the sum of “DBlocks 1” and “DBlocks 2” needs to be computed.
3. From the “Disk Block Number” and “Disk Id” the computed size is read from the disk subsystem.
4. The “DBits” field indicates which blocks on disk are compressed. For example if the bit value is 1 the data span corresponding to “DBlocks 1” is compressed, if the bit value is 2 the data span corresponding to “DBlocks 2” is compressed, if the bit value is 3 the data span corresponding to “DBlocks 1” and “DBlocks 2” are compressed and so on. Based on the “DBits” information the required data is uncompressed.
5. The data corresponding to the BlkEntry would then be from the offset specified by the “DOffset” field till the size specified by the “Effective Data Size” field.

Once the data deduplication check has been completed for a data-segment DDLookup(s) corresponding to file segment data which end in the data-segment can be considered as checked for deduplication. If a DDLookup has been checked for deduplication, the “DChecked” (1901) field is set to a value of “1”. If all the DDLookup(s) for a file have been checked the “DChecked” (1501) field for the file's corresponding DEntry is set to a value of “1”. When all the subdirectories and files in a directory have been checked for data deduplication, the “DChecked” (1501) field for the directory's corresponding DEntry is set to a value of ‘1’.

The advantage of having a “DChecked” field is that the data deduplication operation only needs to process files, directories or file segments which were not earlier processed. Since a DDLookup (which also means the corresponding file and the parent directory) is marked as checked for data deduplication only when the corresponding data-segment has been checked this translates to checking only data-segment(s) which need a deduplication check.

What is claimed is:

1. A method for data deduplication comprising:
receiving a plurality of backup datasets, each backup dataset comprising of a plurality of data blocks;
storing metadata in a plurality of metadata disk segments (meta-segment(s));
storing the received data blocks in a plurality of data disk segments (data-segment(s));
identifying one or more data-segment(s) comprising of duplicate data, wherein the duplicate data in a data-segment is identical to data from one or more previous data-segment(s), and for each identified data-segment modifying metadata corresponding to duplicate data to correspond to the identical data, and releasing the identified data-segment; and
updating metadata for each data-segment checked for data deduplication.

2. The method of claim 1 wherein the step of storing metadata in a plurality of meta-segment(s) comprises of:
storing metadata for the received data blocks;
parsing the received data blocks for directory and file information; and
storing metadata for each parsed directory and file.

3. The method of claim 2 wherein storing metadata for the received data blocks comprises of storing metadata for each received data block and wherein storing metadata for each data block further comprises of storing metadata for a plurality of span of data such that the plurality of span of data together comprises the span of data for the data block.

4. The method of claim 3 wherein storing metadata for a span of data comprises of:
storing location information for the span of data;
storing the size of the span of data;
storing the compression state of the span of data;
storing the size of the data block; and
storing information of the data-segment wherein the span of data is stored.

5. The method of claim 4 wherein the metadata for a span of data is a BlkEntry.

6. The method of claim 2 wherein storing a parsed directory information comprises of storing the name of the directory and the location of the metadata for the directory in the metadata of its corresponding parent directory.

7. The method of claim 6 wherein the metadata for a directory is a DEntryHeader and the directory information stored in the metadata of a parent directory is in a DEntry.

8. The method of claim 2 wherein storing a parsed file information comprises of storing the name of the file and location of the metadata for the file in the metadata of its corresponding parent directory.

9. The method of claim 8 wherein the metadata for a file is a FEntry and the file information stored in the metadata of a parent directory is in a DEntry.

10. The method of claim 6 and claim 8 wherein a parent directory corresponding to a directory or a file is the parent directory determined from the parsed directory information of a dataset and if the directory or file has no parent directory the parent directory is the dataset directory of the backup dataset.

11. The method of claim 10 wherein a dataset directory for a backup dataset is a directory created for each backup dataset received and wherein the name of the dataset directory corresponds to the time when the backup dataset was received.

12. The method of claim 2 wherein parsing the data blocks for file information further comprises of parsing for file segment information corresponding to the file, and for each parsed file segment:
computing fingerprint information for the data corresponding to the file segment;
storing the computed fingerprint information in the metadata corresponding to the file segment;
storing information of the location of the file segment data in the metadata corresponding to the file segment; and
storing information of the location of the metadata corresponding to the file segment in the metadata corresponding to the file.

13. The method of claim 12 wherein the metadata for a file segment is a DDLookup.

14. The method of claim 1 wherein the step of identifying a data-segment with duplicate data further comprises of:
traversing file and directory information stored for each backup dataset and for each file traversed, locating a previous file with an identical traversal path and if found, comparing fingerprint information for each file segment of the file with the fingerprint information of the corresponding file segment in the previous file and, for each file segment of the file with identical fingerprint information identifying data-segment(s) for the data corresponding to the file segment.

15. The method of claim 1 wherein the step of modifying metadata in an identified data-segment further comprises of:
locating the metadata corresponding to the duplicate data in the identified data-segment and modifying the metadata to correspond to the identical data in the previous data-segment(s);
locating metadata corresponding to non duplicate data in the identified data-segment and, copying the non duplicate data to another data-segment and modifying the metadata to correspond to the location where the data was copied.

16. The method of claim 15 wherein the step of modifying metadata to correspond to the identical data in the previous data-segments(s) further comprises of:
modifying metadata to correspond to the location of the identical data;
modifying metadata to correspond to the data-segment of the identical data;
modifying metadata indicating an offset within a plurality of data blocks corresponding to the start of the span of the identical data; and
modifying metadata to indicate the compression state of the plurality of data blocks.

17. The method of claim 14 where in the step of traversing file and directory information comprises of:
reading the stored root directories information and, for each stored root directory information reading its stored dataset directories information and, for each stored dataset directory information traversing its subdirectories and, for each file in a directory, reading its corresponding file information and, traversing the file segment information for each file segment corresponding to the file.

18. The method of claim 14 where in the step of locating a previous file information with an identical traversal path for a file comprises of:
locating a previous dataset directory with a dataset time lesser than the dataset time of the dataset directory corresponding to the file;
starting from the subdirectories of the previous dataset directory and the dataset directory for the file, locating a previous directory information in the previous dataset directory with the names of the directories traversed identical to the name of directories traversed for the file; and
locating a file in the previous directory information wherein the names of the two files identical.

19. The method of claim 18 wherein the dataset time is determined by the name of the dataset directory.

20. The method of claim 1 where in the step of releasing the identified data-segment further comprises of decrementing a reference to the corresponding disk segment.

21. The method of claim 1 wherein the step of updating metadata for each data-segment checked for data deduplication comprises of:
locating metadata corresponding to file segment(s) which end in the data-segment and updating the metadata corresponding to each such file segment indicating that data deduplication has been performed for the file segment;
locating file information for which the metadata corresponding to all the file segments of the file indicate that data deduplication check has been performed and updating the metadata for the file indicating that data deduplication has been performed for the file; and
locating directory information for which the metadata corresponding to all subdirectories and files indicate that data deduplication has been performed and updating the metadata for the directory indicating that data deduplication has been performed for the directory.

22. A system configured for data deduplication, the system comprising:
means for receiving a plurality of backup datasets, each backup dataset comprising of a plurality of data blocks;
means for storing metadata in a plurality of metadata disk segments (meta-segment(s)); means for storing the received data blocks in a plurality of data disk segments (data-segment(s));
means for identifying one or more data-segment(s) comprising of duplicate data, wherein the duplicate data in a data-segment is identical to data from one or more previous data-segment(s), and for each identified data-segment means for modifying metadata corresponding to duplicate data to correspond to the identical data and releasing the identified data-segment; and
means updating metadata for each data-segment checked for data deduplication.

23. A computer readable medium for data deduplication, the computer readable medium including program instructions for performing the steps of:
receiving a plurality of backup datasets, each backup dataset comprising of a plurality of data blocks;
storing metadata in a plurality of metadata disk segments (meta-segment(s));
storing the received data blocks in a plurality of data disk segments (data-segment(s));
identifying one or more data-segment(s) comprising of duplicate data, wherein the duplicate data in a data-segment is identical to data from one or more previous data-segment(s), and for each identified data-segment modifying metadata corresponding to duplicate data to correspond to the identical data, and releasing the identified data-segment; and
updating metadata for each data-segment checked for data deduplication.
